(19) United States
(12) Patent Application Publication
(10) Pub. No.: US 2011/0273528 A1
(43) Pub. Date: Nov. 10, 2011

(54) Simulation program, simulation device, and simulation method

(75) Inventor: Shinichi Sazawa, Kawasaki (JP)

(73) Assignee: FUJITSU LIMITED, Kawasaki (JP)

(21) Appl. No.: 13/064,455

(22) Filed: Mar. 25, 2011

(30) Foreign Application Priority Data
May 10, 2010 (JP) 2010-108443

(51) Int. Cl. G06T 17/00; H04N 7/00

(52) U.S. Cl. 348/36; 345/419; 348/E07.001

(57) ABSTRACT

A simulation device includes a captured image generating unit that generates a captured image captured by an imaging unit disposed virtually at a predetermined view point in a 3D model, the captured image being generated by using the data of the 3D model, a dividing unit that divides the generated captured image into image regions in a predetermined polygonal shape, a computing unit that computes curvatures of the image regions based on the data thereof, an adjusting unit that adjusts sizes of mesh elements on a virtual plane disposed virtually at a predetermined distance from the view point, each of the sizes of the plurality of mesh elements being adjusted by using corresponding each one of the computed curvatures of the image regions, and a wide-angle image generating unit that generates a wide-angle image imaged through a wide-angle lens used in the imaging unit by applying aberration data of the wide-angle lens to the captured image generated in the captured image generating unit according to the adjusted sizes of the mesh elements on the virtual plane.

### CROSS-REFERENCE TO RELATED APPLICATION

This application is based upon and claims the benefit of priority of the prior Japanese Patent Application No. 2010-108443, filed on May 10, 2010, the entire contents of which are incorporated herein by reference.

### FIELD

The embodiments discussed herein are directed to a simulation.

### BACKGROUND

In recent years, cameras with wide-angle lenses that allow the cameras to capture a wider angle of view are widely used for vehicles, buildings, and the like. It is important for the placement design of a camera with a wide-angle lens that the camera is placed at an appropriate position and oriented in an appropriate direction so as not to be obstructed by obstacles.

However, different wide-angle lenses have different distortion characteristics. Therefore, it is difficult to simulate a video image through a wide-angle lens in a simple manner even using a 3D graphics API (Application Program Interface) such as an OpenGL (Open Graphics Library) or DirectX.

In one conventional technique to reproduce an image through a wide-angle lens, perspective images (textures) in six directions are pasted on a mesh of an appropriate division size using, for example, a texture mapping function in cube mapping.
Patent Document 1: Japanese Laid-open Patent Publication No. 2003-264825

However, in the conventional technique to reproduce an image through a wide-angle lens, the load on simulation processing increases as the size of the dividing mesh decreases, and this results in a considerable increase in simulation processing time. Another problem is that the roughness of an image illustrating the results of the simulation processing increases as the size of the dividing mesh increases.

### SUMMARY

According to an aspect of an embodiment of the invention, a simulation device includes a captured image generating unit that generates a captured image captured by an imaging unit disposed virtually at a predetermined view point in a 3D model, the captured image being generated by using data of the 3D model, a dividing unit that divides the captured image generated by the captured image generating unit into a plurality of image regions in a predetermined polygonal shape, a computing unit that computes curvatures of the plurality of image regions based on the data of the 3D model for the plurality image regions, an adjusting unit that adjusts sizes of a plurality of mesh elements on a virtual plane disposed virtually at a predetermined distance from the view point, each of the sizes of the plurality of mesh elements being adjusted by using each of the curvatures computed by the computing unit, and a wide-angle image generating unit that generates a wide-angle image imaged through a wide-angle lens used in the imaging unit by applying aberration data of the wide-angle lens to the captured image generated according to the sizes of the mesh elements adjusted by the adjusting unit.

According to another aspect of an embodiment of the invention, a method for simulating an image executed by a computer includes generating a captured image captured by an imaging unit disposed virtually at a predetermined view point in a 3D model, the captured image being generated by using data of the 3D model, dividing the captured image generated in the generating into a plurality of image regions in a predetermined polygonal shape, computing curvatures of the plurality of image regions based on the data of the 3D model for the plurality of image regions, adjusting sizes of a plurality of mesh elements on a virtual plane disposed virtually at a predetermined distance from the view point, each of the sizes of the plurality of mesh elements being adjusted by using corresponding each one of the curvatures of the plurality of image regions computed in the computing, and generating a wide-angle image imaged through a wide-angle lens used in the imaging unit by applying aberration data of the wide-angle lens to the captured image generated at the generating according to the sizes of the mesh elements adjusted in the adjusting.

According to still another aspect of an embodiment of the invention, a non-transitory computer-readable recording medium that stores a computer program for causing a computer to execute a process includes, first generating a captured image captured by an imaging unit disposed virtually at a predetermined view point in a 3D model, the captured image being generated by using data of the 3D model, dividing the captured image generated in the first generating into a plurality of image regions in a predetermined polygonal shape, first computing curvatures of the plurality of image regions based on the data of the 3D model for the plurality of image regions, adjusting sizes of a plurality of mesh elements on a virtual plane disposed virtually at a predetermined distance from the view point, each of the sizes of the plurality of mesh elements being adjusted by using corresponding each one of the curvatures of the plurality of image regions computed in the first computing, and second generating a wide-angle image imaged through a wide-angle lens used in the imaging unit by applying aberration data of the wide-angle lens to the captured image generated in the first generating according to the sizes of the mesh elements adjusted in the adjusting.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram illustrating the configuration of a simulation device according to a first embodiment;

FIG. 2 is a functional block diagram illustrating the configuration of a simulation device according to a second embodiment;

FIG. 3 is a table illustrating one example of a data structure in a lens aberration storage unit;

FIG. 4 is a diagram illustrating a specific example of a virtual plane;

FIG. 5 is a diagram illustrating a specific example of the generation of captured images;

FIG. 6 is a diagram illustrating a specific example of curvature computation and a specific example of image region adjustment;

FIG. 7 is diagrams illustrating a specific example of the adjustment of the fineness-coarseness of a virtual plane and a specific example of the generation of a wide-angle image;

FIG. 8 is a flowchart illustrating the procedure of simulation processing;

FIG. 9 is a flowchart illustrating the procedure of image region adjustment processing;

FIG. 10 is a diagram illustrating image generation using conventional cube mapping;

FIG. 11 is a diagram illustrating another application of the simulation device;

FIG. 12 is a diagram illustrating a specific example of image region adjustment; and

FIG. 13 is a diagram illustrating a computer that executes a simulation program.

### DESCRIPTION OF EMBODIMENTS

Preferred embodiments of the present invention will be explained with reference to accompanying drawings. In the following embodiments, the invention is applied to video simulations using a virtual wide-angle lens disposed in a three-dimensional model. In the following description, a technique using a texture mapping function in cube mapping is used to achieve the embodiments. However, the invention is not limited to the embodiments.

### [a] First Embodiment

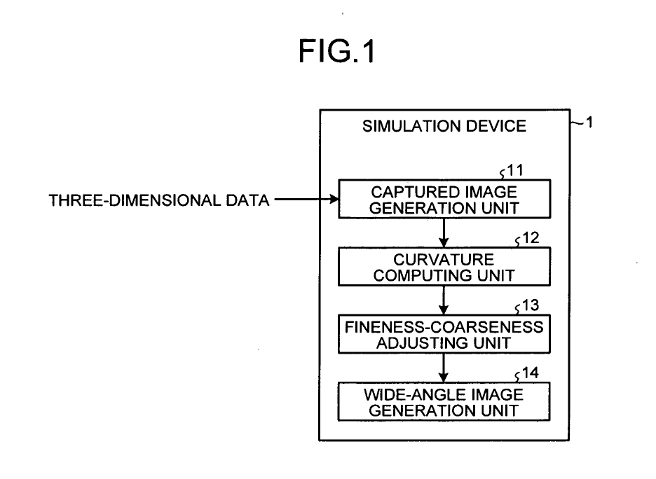

FIG. 1 is a functional block diagram illustrating the configuration of a simulation device according to a first embodiment. As illustrated in FIG. 1, a simulation device 1 includes a captured image generation unit 11, a curvature computing unit 12, a fineness-coarseness adjusting unit 13, and a wide-angle image generation unit 14.

The captured image generation unit 11 generates a captured image captured by an imaging unit disposed virtually at a predetermined view point in a 3D model, the captured image being generated using the data of the 3D model. The curvature computing unit 12 divides the captured image generated by the captured image generation unit 11 into image regions of a predetermined polygonal shape and then computes the curvature of each image region using the data of the image region. An image region with a small computed curvature is a flat and sparse region with small irregularities, and an image region with a large computed curvature is a dense region with large irregularities.

The fineness-coarseness adjusting unit 13 adjusts the sizes of mesh elements on a virtual plane disposed virtually at a predetermined distance from the view point, the sizes of the mesh elements being adjusted according to the curvatures of the corresponding image regions that have been computed by the curvature computing unit 12. The wide-angle image generation unit 14 generates a wide-angle image captured through a wide-angle lens used in the imaging unit by applying the aberration data of the wide-angle lens to the captured image according to the sizes of the mesh elements on the virtual plane that have been adjusted by the fineness-coarseness adjusting unit 13.

As described above, the simulation device 1 divides a captured image into image regions of a predetermined polygonal shape, computes the curvatures of the divided image regions, and adjusts the sizes of the mesh elements on the virtual plane according to the curvatures of the corresponding image regions. Suppose that the simulation device 1 increases the sizes of mesh elements on the virtual plane that correspond to image regions with small curvatures and decreases the sizes of mesh elements on the virtual plane that correspond to image regions with large curvatures. In this case, while the precision of the image is maintained to a certain degree, the processing load on the simulation device 1 may be made smaller than the processing load when the sizes of the mesh elements are uniformly reduced irrespective of the curvatures. Moreover, in the simulation device 1, the image as a whole is less roughened than when the sizes of the mesh elements are uniformly increased irrespective of the curvatures, and therefore the precision of the image may be maintained.

### [b] Second Embodiment

Configuration of Simulation Device in Second Embodiment

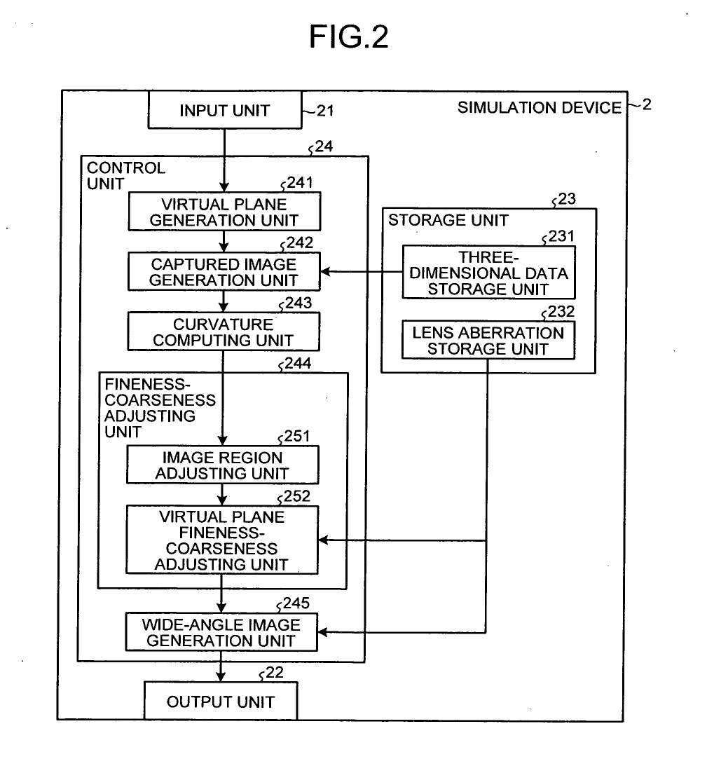

FIG. 2 is a functional block diagram illustrating the configuration of a simulation device 2 according to a second embodiment. The simulation device 2 includes an input unit 21, an output unit 22, a storage unit 23, and a control unit 24.

The input unit 21 allows the user to input operation data and includes, for example, a keyboard, a mouse, or a touch panel display. The output unit 22 outputs an image generated by the control unit 24 and includes, for example, a CRT (Cathode Ray Tube), an LCD (Liquid Crystal Display), or a touch panel display.

The storage unit 23 has a three-dimensional data storage unit 231 and a lens aberration storage unit 232. The storage unit 23 includes, for example, a semiconductor memory device such as a RAM (Random Access Memory) or a flash memory or a storage device such as a hard disk or an optical disk.

The three-dimensional data storage unit 231 stores the data of a 3D model used to prepare the environment for a texture mapping function in cube mapping. More specifically, the three-dimensional data storage unit 231 pre-stores, as the data of the 3D model, a product equipped with a wide-angle camera and a picture taking environment for a simulation. An example of the product equipped with a wide-angle camera is a vehicle equipped with a back-eye camera, and an example of the picture taking environment of the vehicle includes a road, a streetlamp, and a human model of a pedestrian. Another example of the product equipped with a wide-angle camera is a monitoring system equipped with a wide-angle camera used as a monitoring camera, and an example of the picture taking environment of the monitoring system includes a building and a human model of an intruder.

In this embodiment, to use the texture mapping function in cube mapping, images (captured images) captured in six different directions and to be pasted on a cube map may be pre-stored as the data of the 3D model of the picture taking environment. The virtual plane data of a virtual plane generated by a virtual plane generation unit 241 described layer is also pre-stored as 3D model data.

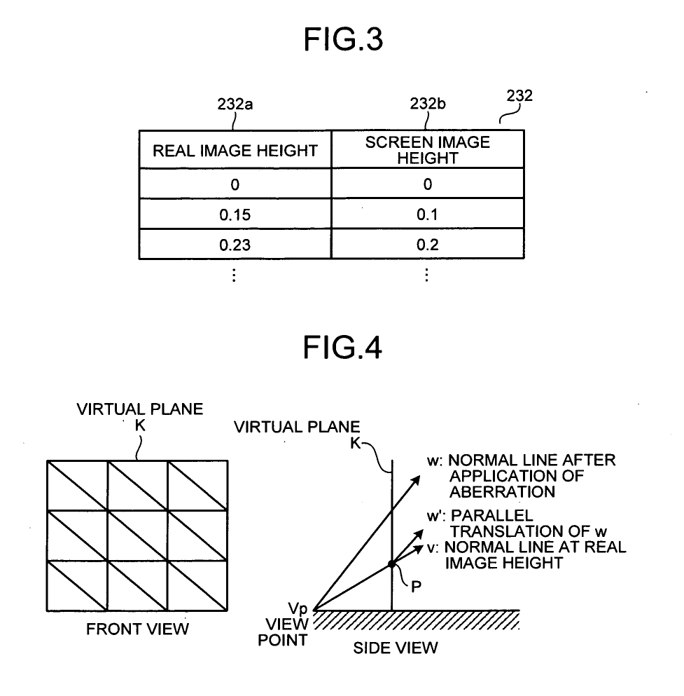

The lens aberration storage unit 232 stores, as the aberration data of wide-angle lenses, real image heights and image heights through each wide-angle lens in a corresponding manner. These values stored in the lens aberration storage unit 232 are determined in advance by, for example, experiments for each of the wide-angle lenses corresponding to virtual lenses to be disposed virtually in the 3D model. The lens aberration storage unit 232 will next be described with reference to FIG. 3. FIG. 3 is a table illustrating an exemplary data structure in the lens aberration storage unit 232. As illustrated in FIG. 3, the lens aberration storage unit 232 stores a real image height 232a and a screen image height 232b in a corresponding manner.

The real image height 232a is the angle of view of the real image taken without using any wide-angle lens, the real image being formed at a position spaced apart from a view point by a predetermined distance. The screen image height 232b is the angle of view of this real image taken through a wide-angle lens. For example, when the real image height 232a is 0.15 degrees, the screen image height 232b is 0.1 degrees. When the real image height 232a is 0.23 degrees, the screen image height 232b is 0.2 degrees. The screen image height 232b (the angle of view) is smaller than the real image height 232a because of the distortion of the wide-angle lens.

The control unit 24 performs processing for an image simulation through a virtual wide-angle lens disposed in the 3D model on the basis of the operation data from the input unit 21. The control unit 24 includes the virtual plane generation unit 241, a captured image generation unit 242, a curvature computing unit 243, a fineness-coarseness adjusting unit 244, and a wide-angle image generation unit 245. The fineness-coarseness adjusting unit 244 includes an image region adjusting unit 251 and a virtual plane fineness-coarseness adjusting unit 252. The control unit 24 is, for example, an integrated circuit such as an ASIC (Application Specific Integrated Circuit) or an FPGA (Field Programmable Gate Array) or an electronic circuit such as a CPU (Central Processing Unit) or an MPU (Micro Processing Unit).

The virtual plane generation unit 241 generates a virtual plane disposed at a position spaced apart from the view point in the 3D model by a predetermined distance. This virtual plane serves as a screen on which the images in six directions pasted on the cube map are projected (texture mapping). More specifically, the virtual plane generation unit 241 acquires, from the three-dimensional data storage unit 231, virtual plane data of the virtual plane disposed at the position spaced apart from the view point by the predetermined distance. The virtual plane data includes the position coordinates of the vertices of elements of an equally divided two-dimensional plane. These elements are used as projection units when the images in six directions pasted on the cube map are projected. Hereinafter, the elements represented by the virtual plane data are referred to as mesh elements. The shape of each mesh element may be, for example, a triangle or a quadrilateral. No particular limitation is imposed on the shape so long as it may be used as the projection unit. The predetermined distance from the view point is, for example, the distance from the view point to the center of the cube map and may be equal to the distance from the view point to the real image when the aberration data stored in the lens aberration storage unit 232 is determined by, for example, experiments.

A specific example of the virtual plane will next be described with reference to FIG. 4. FIG. 4 is a diagram illustrating the specific example of the virtual plane. As illustrated in FIG. 4, the virtual plane K illustrated in a front view is formed of triangular mesh elements of equal shape and size. The virtual plane generation unit 241 acquires the position coordinates of the vertices of these triangular mesh elements from the three-dimensional data storage unit 231.

As illustrated in FIG. 4, the virtual plane K illustrated in a side view is disposed at a position spaced apart from a view point vp by a predetermined distance. The wide-angle image generation unit 245 described later converts a normal line v through point P at a real image height to a normal line w′ extending from the point P and parallel to a normal line w at a screen image height and then projects a texture in the images in six directions pasted on the cube map onto the mesh element at the point P using the normal line w′ to generate a wide-angle image.

The captured image generation unit 242 generates, using the data of the 3D model, captured images captured through a virtual lens disposed virtually at a predetermined view point in the 3D model. More specifically, the captured image generation unit 242 acquires the data of the 3D model of the picture taking environment from the three-dimensional data storage unit 231 and then generates, using the data of the 3D model, captured images in six directions to be pasted on a cube map. To be more specific, the captured image generation unit 242 generates perspective projection images in six directions (front, rear, top, bottom, left, and right directions) captured virtually by a wide-angle camera. When the captured images in six directions to be pasted on the cube map are pre-stored in the three-dimensional data storage unit 231 as 3D model data, the captured image generation unit 242 may simply acquire these captured images in six directions.

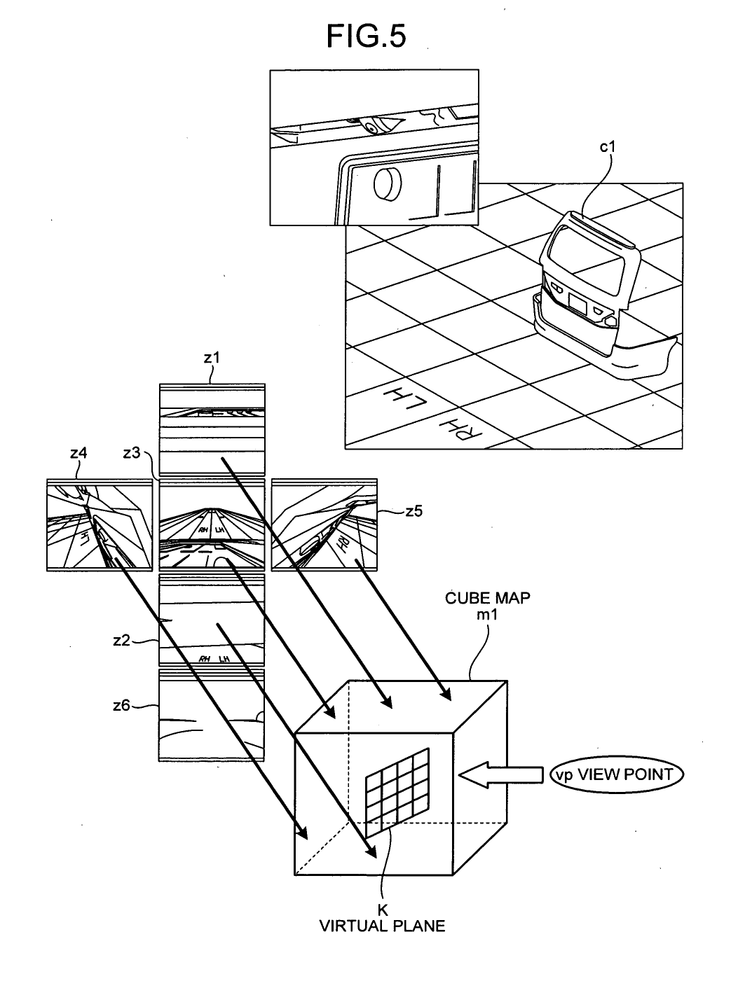

A specific example of the generation of captured images by the captured image generation unit 242 will next be described with reference to FIG. 5. FIG. 5 is a diagram illustrating the specific example of the generation of captured images. As illustrated in FIG. 5, the captured image generation unit 242 generates, as textures for a cube map m1, perspective projection images z1 to z6 of a picture taking environment in a 3D model. The perspective projection images z1 to z6 are taken in six directions (front, rear, top, bottom, left, and right directions) by a wide-angle camera c1 disposed virtually in the 3D model. The picture taking environment is pre-stored in the three-dimensional data storage unit 231 as 3D model data. The cube map m1 is an infinite cube that virtually surrounds the 3D model with the view point vp in the 3D model placed at the center. Further, z1 is a perspective projection image on the top surface as viewed from the view point vp, and z2 is a perspective projection image on the bottom surface as viewed from the view point vp. Moreover, z3 is a perspective projection image on the front surface as viewed from the view point vp, and z4 is a perspective projection image on the left surface as viewed from the view point vp. Further, z5 is a perspective projection image on the right surface as viewed from the view point vp, and z6 is a perspective projection image on the rear surface as viewed from the view point vp.

The curvature computing unit 243 divides each of the images in a plurality of directions generated by the captured image generation unit 242 into image regions of a predetermined polygonal shape and then computes the curvature of each image region using the 3D model data thereof. More specifically, the curvature computing unit 243 divides each of the perspective projection images in six directions (front, rear, top, bottom, left, and right directions) virtually taken by the wide-angle camera into small rectangular image regions of a predetermined size. The curvature computing unit 243 also divides each of these small rectangular image regions into a plurality of polygons and computes the curvature of each of the polygons. Then the curvature computing unit 243 computes the curvature of each small rectangular image region from the computed curvatures of the polygons in the each small rectangular image region.

For example, the curvature computing unit 243 computes the differentiation of the normal to each of the plurality of polygons in each small rectangular image region. Then the curvature computing unit 243 computes the adjacent curvature vector V_{ab} between adjacent polygons A and B from the differentiation fₐ of the normal to the polygon A, the differentiation f_{b} of the normal to the polygon B, and the distance d_{ab} between the centers of gravity of the polygons A and B using equation (1).

v_{ab}=(fₐ−f_{b})/d_{ab} (1)

Then the curvature computing unit 243 computes the curvature pₐ of the polygon A from the adjacent curvature vectors vₐₓ (x=a, b, . . . , n) between the polygon A and all adjacent polygons (for example n polygons) using equation (2).

pₐ=|(v_{ab}+v_{ac}+ . . . +vₐₙ)/n| (2)

Then the curvature computing unit 243 computes the curvature r_{y} (y=1, 2, . . . , m) of each small rectangular image region from the curvatures (for example, three curvatures pₐ, p_{b}, and p_{c}) of all polygons in the each small rectangular image region using equation (3).

r_{y}=(pₐ+p_{b}+p_{c})/3 (3)

The image region adjusting unit 251 computes the average value of the curvatures of the small rectangular image regions included in a perspective projection image for each of the perspective projection images in six directions. In some cases, the image region adjusting unit 251 combines a plurality of adjacent small rectangular image regions into one image region such that the one image region has a curvature close to the average value. In other cases, the image region adjusting unit 251 divides a small rectangular image region into a plurality of image regions such that these image regions have curvatures close to the average value.

More specifically, the image region adjusting unit 251 selects one of the perspective projection images in six directions. Then the image region adjusting unit 251 computes the average value of the curvatures of the small rectangular image regions included in the selected perspective projection image. The image region adjusting unit 251 selects the small rectangular image regions included in the selected perspective projection image one by one and computes the deviation (single curvature deviation) of the curvature of the selected small rectangular image region from the average value. Then, the image region adjusting unit 251 adds up the curvatures of adjacent four small rectangular regions including the selected small rectangular region to compute a combined curvature and then computes the deviation (combined curvature deviation) of the combined curvature from the average value. Then the image region adjusting unit 251 computes a divided curvature by dividing the curvature of the selected small rectangular region by four and then computes the deviation (divided curvature deviation) of the divided curvature from the average value.

When the combined curvature deviation is smaller than the single curvature deviation, the image region adjusting unit 251 combines the four small rectangular regions used to compute the combined curvature deviation into one rectangular region. More specifically, the image region adjusting unit 251 combines a flat small rectangular region having a very small curvature and adjacent small rectangular regions into one rectangular region such that the one rectangular region has a curvature close to the average value. In this manner, dense small rectangular image regions may be converted to a sparse large image region, so that the processing load may be reduced while the precision of the image is maintained to a certain degree. When the divided curvature deviation is smaller than the single curvature deviation, the image region adjusting unit 251 divides the selected small rectangular region used to compute the divided curvature deviation into four rectangular regions. More specifically, the image region adjusting unit 251 divides a very rough small rectangular region having a very large curvature into four rectangular regions such that these rectangular regions have curvatures close to the average value. In this manner, a sparse small rectangular image region may be converted to dense rectangular image regions, and the precision of the image is thereby maintained. As described above, the image region adjusting unit 251 adjusts the sizes of the small rectangular image regions contained in each of the perspective projection images in six directions one by one or simultaneously.

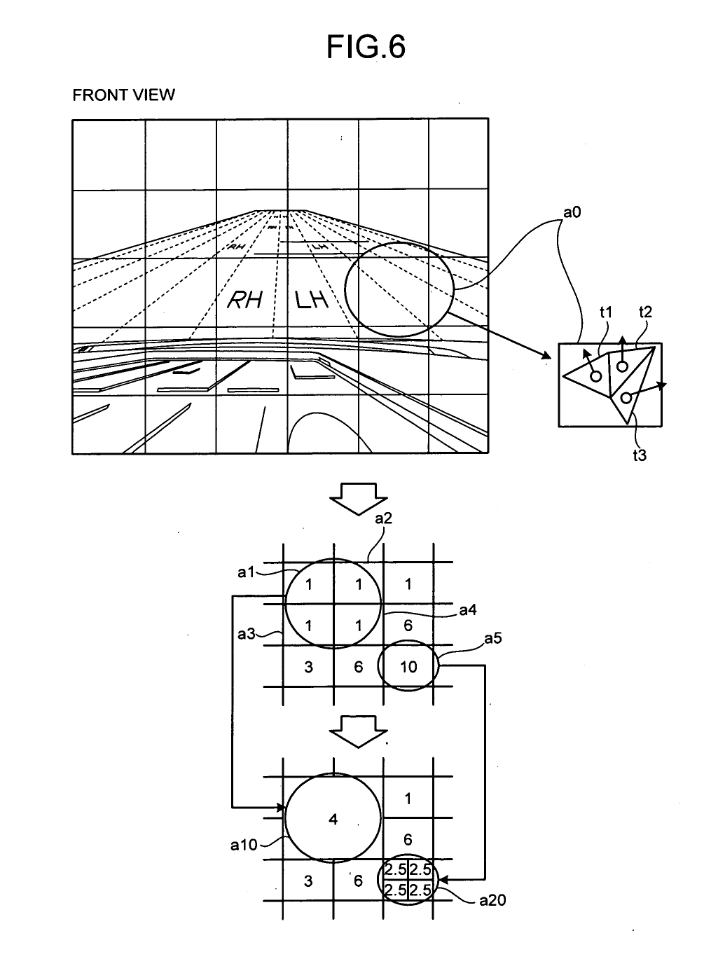

A specific example of the curvature computation by the curvature computing unit 243 and a specific example of the image region adjustment by the image region adjusting unit 251 will next be described with reference to FIG. 6. FIG. 6 is a diagram illustrating the specific examples of the curvature computation and the image region adjustment. As illustrated in FIG. 6, the sizes of the image regions of the perspective projection image on the front surface selected from the perspective projection images in six directions are adjusted. More specifically, the curvature computing unit 243 divides the perspective projection image on the front surface into small rectangular image regions. Then the curvature computing unit 243 divides each of these small rectangular image regions into a plurality of polygons. In this example, the curvature computing unit 243 divides a small rectangular image region a0 into a plurality of triangular polygons t1 to t3. Then the curvature computing unit 243 computes the curvatures of the plurality of divided polygons t1 to t3 in the small rectangular image region a0 using the differentiation of the normals to the polygons t1 to t3 and then computes the curvature of the small rectangular image region a0 from the computed curvatures of the polygons.

Next, the image region adjusting unit 251 computes the average value of the curvatures of the small rectangular image regions included in the perspective projection image on the front surface. In this example as illustrated in FIG. 6, the curvatures of the small rectangular image regions included in the perspective projection image on the front surface are 1, 1, 1, 1, 1, 6, 3, 6, and 10, and then the average value of the curvatures is computed as “3.3”.

Next, the image region adjusting unit 251 selects the small rectangular regions included in the perspective projection image on the front surface one by one and then adjusts the size of the selected small rectangular image region. For example, the image region adjusting unit 251 selects a small rectangular region a1 included in the perspective projection image on the front surface and then computes the single curvature deviation of the curvature of the small rectangular region a1 (“1”) from the average value “3.3”. In this case, the single curvature deviation is computed as “2.2”. The image region adjusting unit 251 also computes the combined curvature by adding up the curvature (“1”) of the selected small rectangular region a1 and the curvatures of three adjacent small rectangular regions a2 to a4 (the combined curvature is “4” in this case) and then computes the combined curvature deviation of the combined curvature (“4”) from the average value (“3.3”). In this case, the combined curvature deviation is computed as “0.7”. Then the image region adjusting unit 251 computes the divided curvature by dividing the curvature of the selected small rectangular region a1 by four (the divided curvature is “0.25” in this case) and then computes the divided curvature deviation of the divided curvature (“0.25”) from the average value (“3.3”). In this case, the divided curvature deviation is computed as “3.05”. The single curvature deviation is “2.2”, the combined curvature deviation is “0.7”, and the divided curvature deviation is “3.05”. Therefore, the combined curvature deviation is smaller than the single curvature deviation, and the divided curvature deviation is not smaller than the single curvature deviation. Therefore, the image region adjusting unit 251 combines the four small rectangular regions a1 to a4 used to compute the combined curvature deviation into one rectangular region a10.

Next, the image region adjusting unit 251 selects a small rectangular region a5 included in the perspective projection image on the front surface and then computes the single curvature deviation of the curvature of the small rectangular region a5 (“10”) from the average value (“3.3”). In this case, the single curvature deviation is computed as “6.7”. The image region adjusting unit 251 also computes the combined curvature by adding up the curvature (“10”) of the selected small rectangular region a5 and the curvatures of three adjacent small rectangular regions (not illustrated) and then computes the combined curvature deviation of the combined curvature from the average value (“3.3”). In this case, the combined curvature deviation is greater than the single curvature deviation (“6.7”). Then the image region adjusting unit 251 computes the divided curvature by dividing the curvature of the selected small rectangular region a5 by four (the divided curvature is “2.5” in this case) and then computes the divided curvature deviation of the divided curvature (“2.5”) from the average value (“3.3”). In this case, the divided curvature deviation is computed as “0.8”. The single curvature deviation is “6.7”, the combined curvature deviation is greater than “6.7”, and the divided curvature deviation is “0.8”. Therefore, the combined curvature deviation is not smaller than the single curvature deviation, and the divided curvature deviation is smaller than the single curvature deviation. Therefore, the image region adjusting unit 251 divides the selected small rectangular region a5 used to compute the divided curvature deviation into four small rectangular regions a20.

Returning to FIG. 2, the virtual plane fineness-coarseness adjusting unit 252 converts the heights of the image regions adjusted by the image region adjusting unit 251 to heights to be captured through a virtual lens on the basis of the aberration data of this wide-angle lens and then adjusts the sizes of mesh elements on the virtual plane according to the sizes of the corresponding converted image regions. More specifically, the virtual plane fineness-coarseness adjusting unit 252 consults the lens aberration storage unit 232, converts the coordinates of the vertices of each rectangular region of the divided perspective projection image on the front surface as viewed from the view point to the coordinates for the image height through the wide-angle lens, and then adjusts the size of the each rectangular region. Then the virtual plane fineness-coarseness adjusting unit 252 adjusts the size of each rectangular region of the perspective projection images in five directions other than the perspective projection image on the front surface as viewed from the view point in a manner similar to that for the front surface. The virtual plane fineness-coarseness adjusting unit 252 also adjusts the sizes of the mesh elements on the virtual plane according to the sizes of the corresponding adjusted rectangular regions of the perspective projection images in six directions. More specifically, the virtual plane fineness-coarseness adjusting unit 252 adjusts the sizes of the mesh elements on the virtual plane according to the sizes (curvatures) of the corresponding original rectangular regions of the perspective projection images in six directions.

The wide-angle image generation unit 245 generates a wide-angle image captured through a wide-angle lens used as the virtual lens in the 3D model by applying the aberration data of the wide-angle lens to each perspective projection image according to the adjusted sizes of the mesh elements on the virtual plane that have been adjusted by the virtual plane fineness-coarseness adjusting unit 252. More specifically, the wide-angle image generation unit 245 consults the lens aberration storage unit 232 and converts the normal line at the real image height of each mesh element on the virtual plane to the normal line at the screen image height. Then the wide-angle image generation unit 245 projects a perspective projection image texture at a position where the converted normal line intersects the cube map onto the each mesh element to generate a wide-angle image. Then the output unit 22 displays the generated wide-angle image for each mesh element generated on the virtual plane by the wide-angle image generation unit 245 on, for example, a monitor.

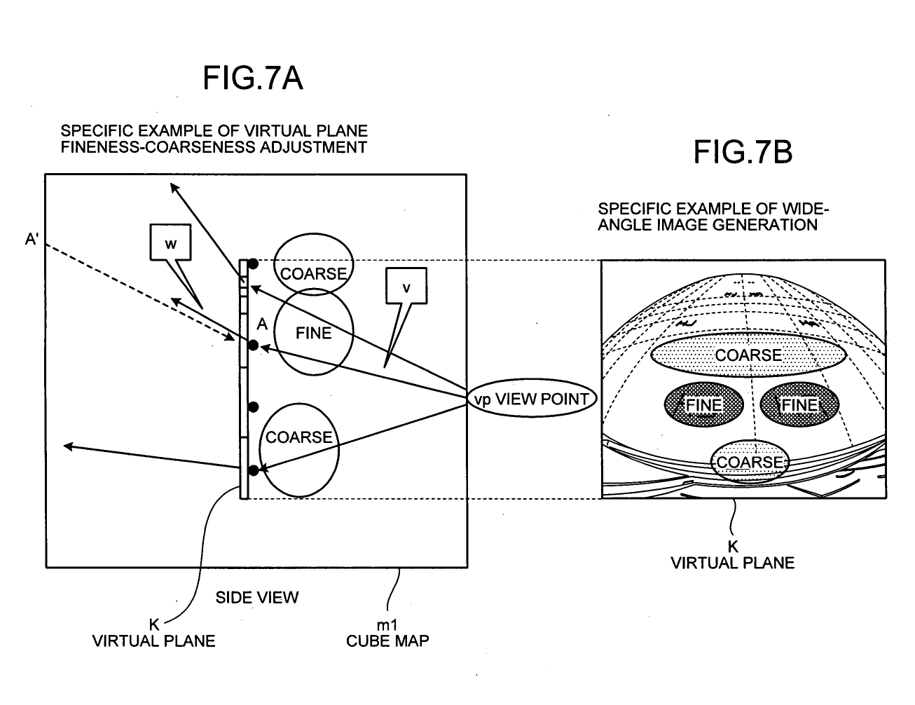

A specific example of the adjustment of the fineness-coarseness of the virtual plane by the virtual plane fineness-coarseness adjusting unit 252 and a specific example of the generation of a wide-angle image by the wide-angle image generation unit 245 will next be described with reference to FIGS. 7A and 7B. FIGS. 7A and 7B are diagrams illustrating the specific examples of the adjustment of the fineness-coarseness of the virtual plane and the generation of a wide-angle image. FIG. 7A illustrates the specific example of the adjustment of the fineness-coarseness of the virtual plane, and FIG. 7B illustrates the specific example of the generation of a wide-angle image. As illustrated in FIG. 7A, the fineness-coarseness of the virtual plane K spaced apart from the view point vp in the 3D model by a predetermined distance is determined according to the sizes of the rectangular regions of each of the perspective projection images pasted on the cube map m1. In FIG. 7A, a normal line v at a real image height at point A on the virtual plane K is converted to a normal line w at a screen image height, and the virtual plane fineness-coarseness adjusting unit 252 relates a region around the point A as its center to a small rectangular region at a position on a perspective projection image at which the normal line w intersects the cube map m1. The virtual plane fineness-coarseness adjusting unit 252 relates each point on the virtual plane K to each small rectangular region of the perspective projection images in six directions pasted on the cube map m1 in the same manner as that for the point A. Therefore, the sizes of the mesh elements on the virtual plane K are determined according to the sizes (curvatures) of the corresponding original small rectangular regions of perspective projection images.

As illustrated in FIG. 7B, textures of the perspective projection images pasted on the cube map m1 are projected onto the mesh elements on the virtual plane K according to their sizes, and a wide-angle image is thereby generated. More specifically, the wide-angle image generation unit 245 projects, onto a mesh element on the virtual plane K, the texture of a perspective projection image at which the normal line through that mesh element intersects the cube map m1, according to the size of the mesh element. Therefore, a flat image having small curvatures that corresponds to rough mesh elements is generated on a coarse mesh portion on the virtual plane K. However, a rough image having large curvatures that corresponds to fine mesh elements is generated on a fine mesh portion on the virtual plane K.

Procedure of simulation processing in second embodiment is described below.

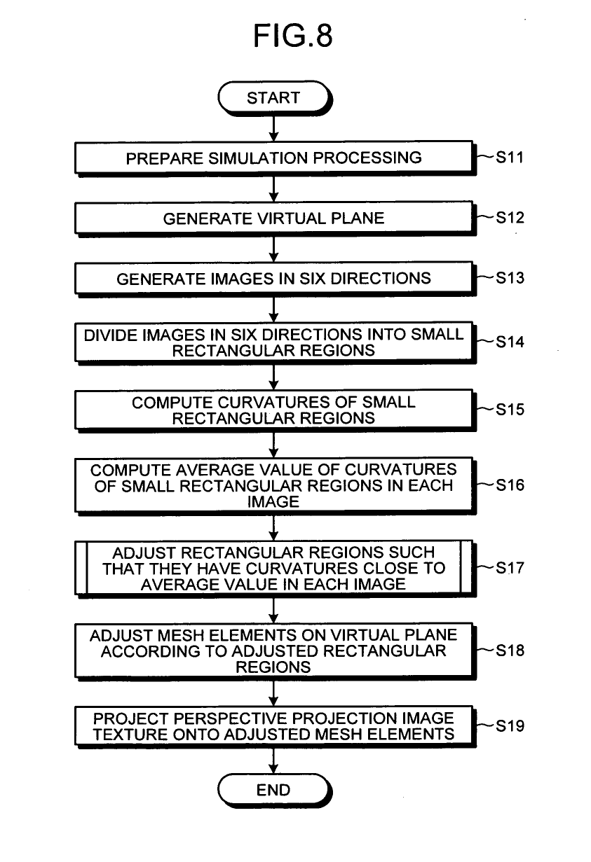

The procedure of the simulation processing according to the second embodiment will next be described with reference to FIG. 8. FIG. 8 is a flowchart illustrating the procedure of the simulation processing.

First, to prepare the simulation processing, various types of data are pre-stored in the three-dimensional data storage unit 231 and the lens aberration storage unit 232 (step S11). The three-dimensional data storage unit 231 stores the data of a 3D model that is used to prepare the texture mapping function environment in cube mapping. The lens aberration storage unit 232 stores, as the aberration data of wide-angle lenses, each real image height and each image height through each wide-angle lens in a corresponding manner.

Next, the virtual plane generation unit 241 generates a virtual plane disposed at a position spaced apart from a view point in the 3D model by a predetermined distance (step S12). Then the captured image generation unit 242 generates, using the data of the 3D model stored in the three-dimensional data storage unit 231, perspective projection images captured in six directions by a virtual lens disposed virtually at the view point in the 3D model (step S13).

Next, the curvature computing unit 243 divides each of the perspective projection images in six directions generated by the captured image generation unit 242 into small rectangular image regions (step S14). Then the curvature computing unit 243 divides each of these small rectangular image regions into a plurality of polygons and computes the curvature of each of these polygons. The curvature computing unit 243 then computes the curvature of each small rectangular image region from the curvatures of the polygons included therein (step S15).

Next, the image region adjusting unit 251 computes the average value of the curvatures of the small rectangular image regions of a perspective projection image for each of the perspective projection images in six directions (step S16). Then the image region adjusting unit 251 adjusts the rectangular regions of each perspective projection image such that the adjusted rectangular regions have curvatures close to the average value (step S17).

Next, the virtual plane fineness-coarseness adjusting unit 252 consults the lens aberration storage unit 232, converts the coordinates of the vertices of each adjusted rectangular region of each divided perspective projection image to the coordinates for the image height through the wide-angle lens, and then adjusts the size of the each rectangular region. Then the virtual plane fineness-coarseness adjusting unit 252 adjusts the sizes of the mesh elements on the virtual plane according to the sizes of the corresponding adjusted rectangular regions of the perspective projection images in six directions (step S18). More specifically, the virtual plane fineness-coarseness adjusting unit 252 adjusts the sizes of the mesh elements on the virtual plane according to the sizes (curvatures) of the corresponding rectangular regions of the perspective projection images in six directions.

Next, the wide-angle image generation unit 245 consults the lens aberration storage unit 232 and converts the normal line at the real image height of each mesh element on the virtual plane to the normal line at the screen image height. Then the wide-angle image generation unit 245 projects a perspective projection image texture at a position where the converted normal line intersects the cube map onto the each mesh element (step S19) to generate a wide-angle image.

Procedure of image region adjustment processing is described below.

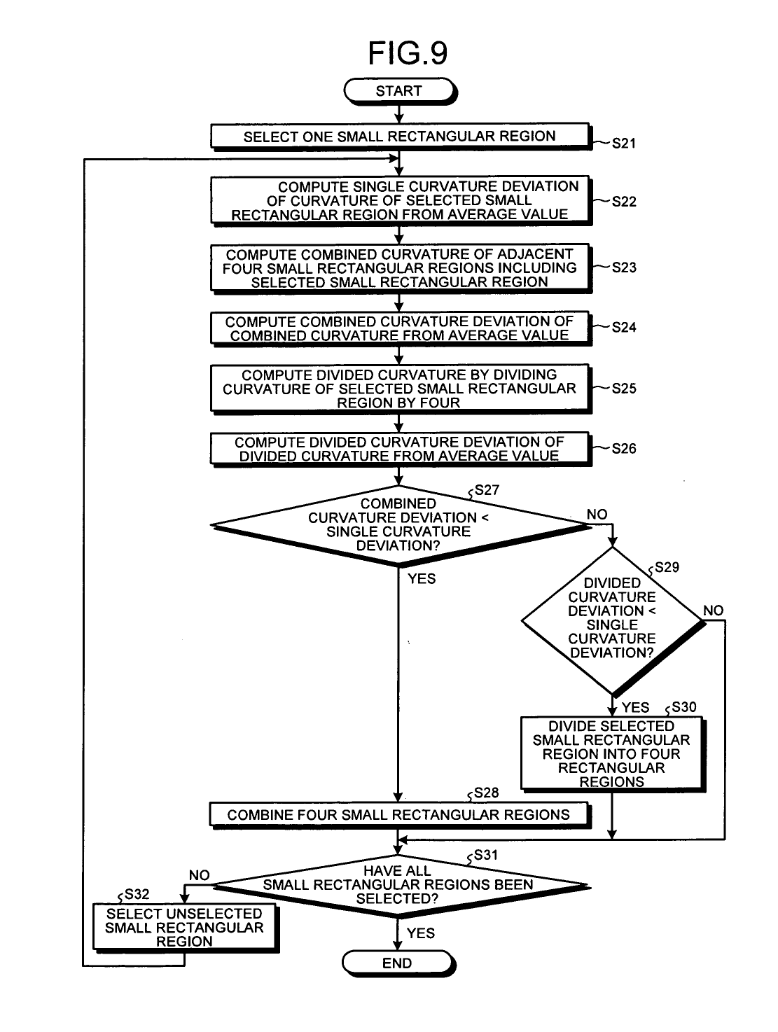

The procedure of the image region adjustment processing according to the second embodiment will next be described with reference to FIG. 9. FIG. 9 is a flowchart illustrating the procedure of the image region adjustment processing.

First, the image region adjusting unit 251 selects one small rectangular region included in a perspective projection image (step S21). Then the image region adjusting unit 251 computes the deviation (single curvature deviation) of the curvature of the selected small rectangular region from the average value (step S22).

Then the image region adjusting unit 251 computes the combined curvature of adjacent four small rectangular regions including the selected small rectangular region (step S23). The image region adjusting unit 251 computes the deviation (combined curvature deviation) of the computed combined curvature from the average value (step S24).

Next, the image region adjusting unit 251 computes a divided curvature by dividing the curvature of the selected small rectangular region by four (step S25). Then the image region adjusting unit 251 computes the deviation (divided curvature deviation) of the divided curvature from the average value (step S26).

Next, the image region adjusting unit 251 determines whether or not the combined curvature deviation is smaller than the single curvature deviation (step S27). If a determination is made by the image region adjusting unit 251 that the combined curvature deviation is smaller than the single curvature deviation (Yes in step S27), the image region adjusting unit 251 combines the four small rectangular regions used for the combined curvature deviation into one rectangular region (step S28).

If a determination is made by the image region adjusting unit 251 that the combined curvature deviation is not smaller than the single curvature deviation (No in step S27), the image region adjusting unit 251 determines whether or not the divided curvature deviation is smaller than the single curvature deviation (step S29). If a determination is made by the image region adjusting unit 251 that the divided curvature deviation is smaller than the single curvature deviation (Yes in step S29), the image region adjusting unit 251 divides the selected small rectangular region into four rectangular regions (step S30). If a determination is made by the image region adjusting unit 251 that the divided curvature deviation is not smaller than the single curvature deviation (No in step S29), the process moves to step S31.

Next, the image region adjusting unit 251 determines whether or not all the small rectangular regions have been selected (step S31). If four small rectangular regions are combined into one rectangular region, the image region adjusting unit 251 considers that these small rectangular regions have already been selected, and these small rectangular regions are eliminated from the selection process. If not all the small rectangular regions have been selected by the image region adjusting unit 251 (No in step S31), the image region adjusting unit 251 selects an unselected small rectangular region (step S32). Then the image region adjusting unit 251 executes step S22. If all the small rectangular regions have been selected by the image region adjusting unit 251 (Yes in step S31), the image region adjusting unit 251 ends the image region adjustment processing.

In the second embodiment described above, the image region adjusting unit 251 computes the average value of the curvatures of the rectangular image regions of each perspective projection image. Preferably, the image region adjusting unit 251 combines a plurality of adjacent image regions into one image region so that the one image region has a curvature close to the average value or divides one image region into a plurality of image regions so that these image regions have curvatures close to the average value. Then the virtual plane fineness-coarseness adjusting unit 252 consults the aberration data of the wide-angle lens, converts the heights of the adjusted image regions adjusted by the image region adjusting unit 251 to heights to be captured by the virtual wide-angle lens, and then adjusts the sizes of the mesh elements on the virtual plane according to the converted image regions.

In this configuration, since the sizes of some small rectangular regions are adjusted such that the adjusted small rectangular regions have curvatures close to the average value, the sizes of the mesh elements on the virtual plane may be adjusted according to the adjusted sizes of the corresponding small rectangular regions. More specifically, the sizes of the mesh elements on the virtual plane may be adjusted according to the sizes of the small rectangular regions with small curvature variations. Therefore, if the curvature of a small rectangular image region is large, this small rectangular region is divided into smaller regions, and the sizes of the mesh elements corresponding to these smaller regions may be reduced. This may generate a fine mesh portion, and the precision of the image projected onto the fine mesh portion may be maintained. If the curvature of a small rectangular image region is small, this small rectangular image region is combined with adjacent image regions, and the size of the mesh element on the virtual plane corresponding to the combined small rectangular regions may be increased. This may generate a coarse mesh portion, and the precision of the image projected onto the coarse mesh portion may be maintained. Therefore, while the precision of the image as a whole is maintained to a certain degree, the processing load may be made smaller than the processing load compared with a case where the sizes of the mesh elements are uniformly reduced.

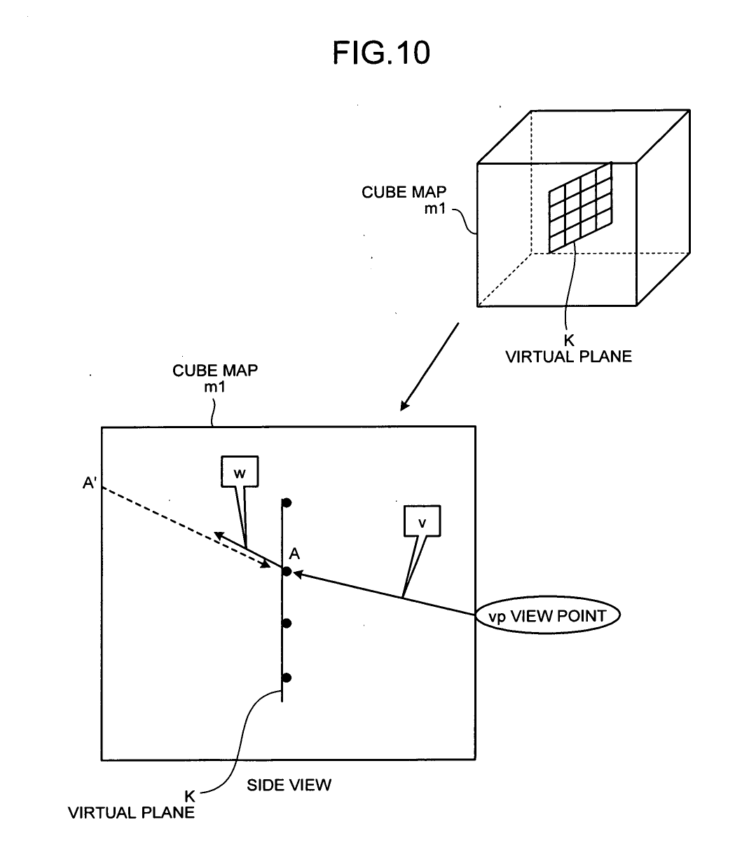

The generation of an image on a virtual plane from a cube map in a conventional technology will next be described. FIG. 10 is a diagram illustrating the image generation using the cube map in the conventional technology. As illustrated in FIG. 10, the mesh elements on the virtual plane K are uniform. A perspective projection image texture at a position at which a normal line through a mesh element on the virtual plane K intersects the cube map is projected onto the mesh element. In FIG. 10, a normal line v at a real image height at point A on the virtual plane K is converted to a normal line w at a screen image height, and a texture A′ at a position at which the normal line w intersects the cube map m1 is projected onto a mesh region around the point A as its center. Therefore, if uniform fine mesh elements are used, the processing load of image generation may be large. If uniform coarse mesh elements are used, the image generated by the image generation may be rough.

However, in the second embodiment, the virtual plane fineness-coarseness adjusting unit 252 customizes the sizes of the mesh elements according to the fineness-coarseness of images adjusted by the image region adjusting unit 251 using the curvatures of the original image regions, and the fineness-coarseness of the images projected onto the mesh elements may thereby be adjusted. Therefore, while the precision of the image as a whole is maintained to a certain degree, the processing load of image generation may be made smaller than the processing load as compared to that when uniform fine mesh elements are used. In addition, the precision of the image generated by the image generation may be maintained to a higher degree as compared to that when uniform coarse mesh elements are used.

In the second embodiment, the output unit 22 outputs an image generated by the wide-angle image generation unit 245 for each mesh element on the virtual plane. In this configuration, since the image generated for each mesh element on the virtual plane is output, the speed of the output processing may be higher than that as compared to that when uniform coarse mesh elements are used.

An application of the simulation device 2 will next be described. In the second embodiment, with the view point in the 3D model fixed, an image through the virtual wide-angle lens is generated. However, the simulation device 2 may be used while the view point in the 3D model is moved. In this case, an image through the virtual wide-angle lens may be generated in a manner similar to that when the view point in the 3D model is fixed. More specifically, after a wide-angle image through the virtual lens at the current view point is generated by the wide-angle image generation unit 245 (step S19 in the simulation processing, see FIG. 8), the wide-angle image generation unit 245 determines whether or not the view point has been moved. If a determination is made that the view point has been moved, the process moves to the step of generating images in six directions captured from the moved view point (step S13). In this manner, for example, in the design of the back-eye camera of a vehicle, the placement design of the back-eye camera may be made in an efficient manner. In addition, for example, in a monitoring system using a wide-angle camera, an appropriate placement position of the wide-angle camera may be examined in advance.

Another application of the simulation device 2 will next be described. When the view point in the 3D model is moved over time, for example, when a video is displayed, high processing speed is required rather than the precision of the image. In such a case, the image region adjusting unit 251 may simply combine adjacent small rectangular image regions into single image regions such that the single image regions have curvatures close to the average value. The image region adjusting unit 251 may use, instead of the average value of the curvatures of the small rectangular image regions included in a perspective projection image, the average value of the curvatures in each of images obtained by dividing the perspective projection image to adjust small rectangular image regions corresponding to the each of the images. In the design of, for example, the back-eye camera of a vehicle, the placement design of the back-eye camera may thereby be made in a more efficient manner. In addition, for example, in a monitoring system using a wide-angle camera, an appropriate placement position of the wide-angle camera may be examined in advance. To move the view point over time, for example, the user may move the view point manually through the input unit 21 (for example, a mouse). Alternatively, the view point may be automatically moved at regular time intervals. However, the invention is not limited thereto.

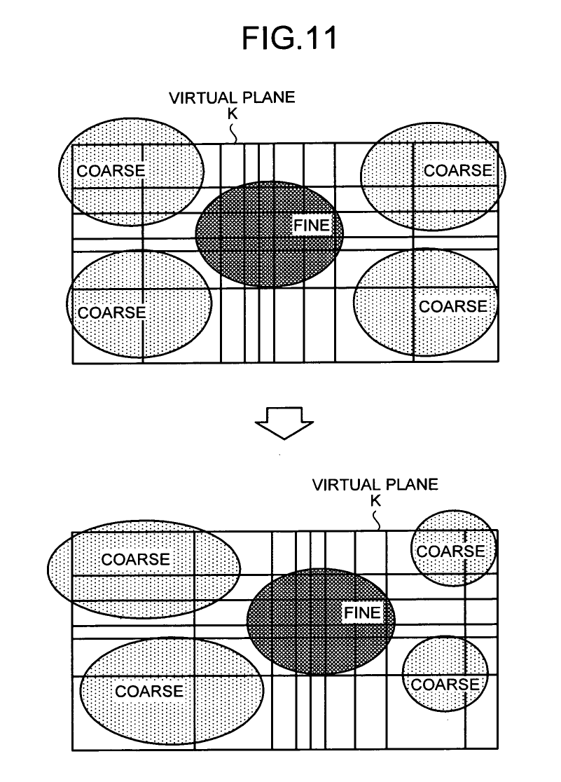

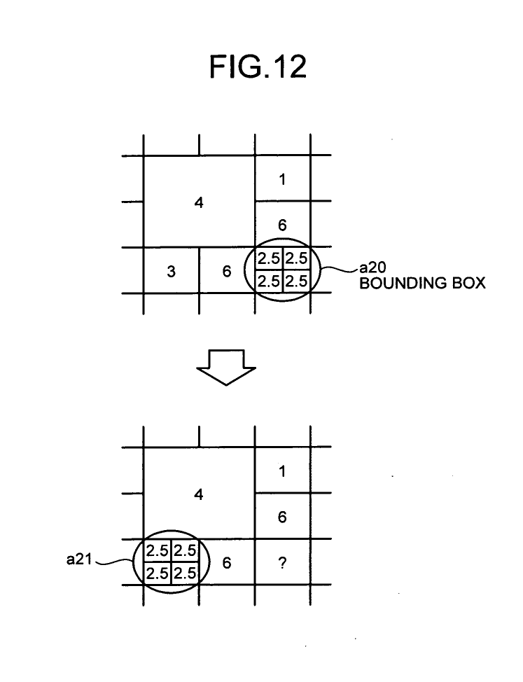

When an object included in a perspective projection image is moved without moving the view point in the 3D model, for example, the user may operate the object through the input unit 21 (for example, a mouse). This procedure will be described as another application of the simulation device 2 with reference to FIGS. 11 and 12. FIG. 11 is a diagram illustrating this application of the simulation devise, and FIG. 12 is a diagram illustrating a specific example of image region adjustment. In the description below, a particular object included in a perspective projection image is moved. If the sizes of mesh elements on a virtual plane K onto which the object before the movement is projected are, for example, small, the size of each mesh element for that object after the movement is set to be the same as the size of the corresponding small mesh element before the movement, as illustrated in FIG. 11. As illustrated in FIG. 12, the image region adjusting unit 251 combines or divides small rectangular image regions included in the perspective projection image such that the resultant small rectangular image regions have curvatures close to the average value. During this procedure, the image region adjusting unit 251 acquires a small rectangle that surrounds the particular object, i.e., a bounding box a20. Then the image region adjusting unit 251 stores the sizes (curvatures) of small rectangular regions in the bounding box a20 temporarily in the storage unit 23. After the particular object is moved, the image region adjusting unit 251 replaces the sizes (curvatures) of small rectangular regions in a bounding box a21 at the destination of the movement with the sizes (curvatures) stored in the storage unit 23. The virtual plane fineness-coarseness adjusting unit 252 may thereby set the sizes of the mesh elements for the object after the movement to be the same as those before the movement. In this manner, the rate of video display may be increased while the image quality of the operated object is maintained to a certain degree.

Other Modifications

In the description of the second embodiment, the image region adjusting unit 251 uses “4” as the unit of combination of a plurality of small rectangular regions into one rectangular region and also as the unit of division of one small rectangular region into a plurality of rectangular regions. However, these units used in the image region adjusting unit 251 are not limited thereto. The units of combination and division may be “2,” “3,” or “5,” but this is not a limitation.

Each of the simulation devices 1 and 2 may be achieved by providing the functions of the control unit 24 and the storage unit 23 to a known information processing device such as a personal computer or a workstation.

The constituent components of the devices illustrated in the figures are not necessarily configured physically in the manner illustrated in the figures. More specifically, the specific configuration of the distribution and integration of each device are not limited to those illustrated in the figures. A part of or all the constituent components may be freely distributed or integrated functionally or physically according to various loads, use conditions, and other factors. For example, the curvature computing unit 243 and the fineness-coarseness adjusting unit 244 may be integrated into a single unit. The image region adjusting unit 251 may be divided into, for example, an average curvature computing unit that computes the average value of the curvatures of the small rectangular image regions of each perspective projection image and an image dividing-combining unit that divides or combines small rectangular image regions such that the resultant image regions have curvatures close to the average value. The storage unit 23 may be connected as an external device to the simulation device 2 through a network. The input unit 21 and the output unit 22 may be included in another device, and the above-described functions of the simulation device 2 may be achieved by cooperation with the input unit 21 and the output unit 22 connected through a network.

Program

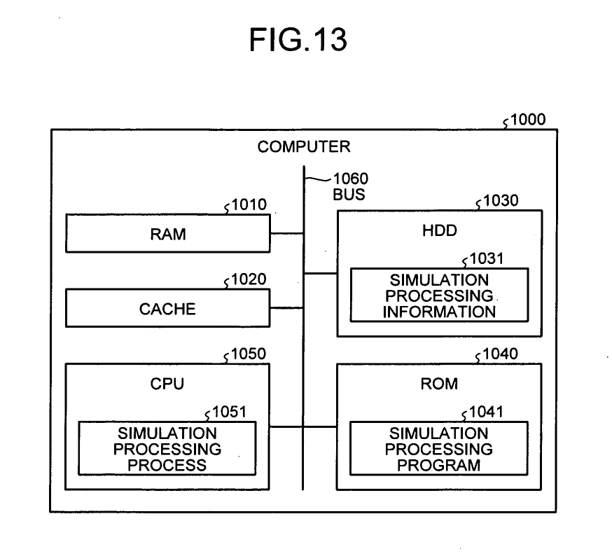

The various types of processing described in the above embodiments may be achieved by executing pre-installed programs on a computer such as a personal computer or a workstation. Therefore, an exemplary computer that executes a simulation program having the same functions as those of the simulation device 2 illustrated in FIG. 2 will next be described with reference to FIG. 13.

FIG. 13 is a diagram illustrating the computer that executes the simulation program. As illustrated in FIG. 13, a computer 1000 includes a RAM (Random Access Memory) 1010, a cache 1020, a HDD 1030, a ROM (Read Only Memory) 1040, a CPU (Central Processing Unit) 1050, and a bus 1060. The RAM 1010, the cache 1020, the HDD 1030, the ROM 1040, and the CPU 1050 are connected through the bus 1060.

A simulation processing program 1041 that has the same functions as those of the simulation device 2 illustrated in FIG. 2 is pre-stored in the ROM 1040. More specifically, the simulation processing program 1041 includes a virtual plane generation program, an image acquisition program, a curvature computation program, a fineness-coarseness adjustment program, and an image generation program.

The CPU 1050 reads and executes the simulation processing program 1041. The simulation processing program 1041 is thereby used as a simulation processing process 1051, as illustrated in FIG. 13. The simulation processing process 1051 corresponds to the control unit 24 illustrated in FIG. 2.

Simulation processing information 1031 is provided in the HDD 1030, as illustrated in FIG. 13. The simulation processing information 1031 corresponds to, for example, various types of data stored in the storage unit 23 (i.e., the three-dimensional data storage unit 231 and the lens aberration storage unit 232) illustrated in FIG. 2.

The program 1041 described above is not necessarily stored in the ROM 1040. For example, the program 1041 may be stored in a “portable physical medium” inserted into the computer 1000, such as a flexible disk (FD), a CD-ROM, an MO-disc, a DVD disc, a magneto-optical disc, or an IC card. The program 1041 may be stored in a “fixed physical medium,” such as a hard disk drive (HDD), installed inside or outside the computer 1000. The program 1041 may be stored in “another computer (or server)” connected to the computer 1000 through a public network, the Internet, LAN, or WAN. The computer 1000 may read the program from, for example, a flexible disk to execute the program.

According to one aspect of the simulation program disclosed in the present application, the load on the processing may be advantageously reduced while the precision of the simulation image according to the distortion of the wide-angle lens is ensured.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a computer program for causing a computer to execute a process, the process comprising:
first generating a captured image captured by an imaging unit disposed virtually at a predetermined view point in a 3D model, the captured image being generated by using data of the 3D model;
dividing the captured image generated in the first generating into a plurality of image regions in a predetermined polygonal shape;
first computing curvatures of the plurality of image regions based on the data of the 3D model for the plurality image regions;
adjusting sizes of a plurality of mesh elements on a virtual plane disposed virtually at a predetermined distance from the view point, each of the sizes of the plurality of mesh elements being adjusted by using corresponding each one of the curvatures of the plurality of image regions computed in the first computing; and
second generating a wide-angle image imaged through a wide-angle lens used in the imaging unit by applying aberration data of the wide-angle lens to the captured image generated in the first generating according to the sizes of the mesh elements adjusted in the adjusting.

2. The computer-readable, non-transitory medium according to claim 1, wherein the adjusting includes
second computing an average value of the curvatures of the plurality of image regions,
combining a plurality of adjacent image regions of the plurality of image regions into one image region such that the one image region has a curvature close to the average value,
dividing an image region of the plurality of image regions into a plurality of divided image regions such that the plurality of divided image regions have curvatures close to the average value,
converting, using the aberration data, a height of each of the plurality of image regions adjusted in the combining and the dividing to a height to be captured by the imaging unit, and
adjusting the size of each of the plurality of mesh elements on the virtual plane according to the size of corresponding each one of the plurality of adjusted image regions whose height is converted in the converting.

3. The computer-readable, non-transitory medium according to claim 2, wherein, when the view point is moved over time, the second computing includes computing the average value of the curvatures of the plurality of image regions, and the combining includes combining a plurality of adjacent image regions of the plurality of image regions into one image region such that the one image region has a curvature close to the average value.

4. The computer-readable, non-transitory medium according to claim 2, wherein, when an object included in the captured image is moved without moving the view point, the second computing includes replacing a curvature of an image region including the object after movement with a curvature of an image region including the object before movement.

5. The computer-readable, non-transitory medium according to claim 1, the process further comprising:
outputting the wide-angle image generated on the virtual plane in the second generating, the wide-angle image being outputted for each of the plurality of mesh elements.

6. A simulation device comprising:
a captured image generating unit that generates a captured image captured by an imaging unit disposed virtually at a predetermined view point in a 3D model, the captured image being generated by using data of the 3D model;
a dividing unit that divides the captured image generated by the captured image generating unit into a plurality of image regions in a predetermined polygonal shape;
a computing unit that computes curvatures of the plurality of image regions based on the data of the 3D model for the plurality image regions;
an adjusting unit that adjusts sizes of a plurality of mesh elements on a virtual plane disposed virtually at a predetermined distance from the view point, each of the sizes of the plurality of mesh elements being adjusted by using corresponding each one of the curvatures of the plurality of image regions computed by the computing unit; and
a wide-angle image generating unit that generates a wide-angle image imaged through a wide-angle lens used in the imaging unit by applying aberration data of the wide-angle lens to the captured image generated according to the sizes of the mesh elements adjusted by the adjusting unit.

7. A method for simulating an image executed by a computer, the method comprising:
generating a captured image captured by an imaging unit disposed virtually at a predetermined view point in a 3D model, the captured image being generated by using data of the 3D model;
dividing the captured image generated in the generating into a plurality of image regions in a predetermined polygonal shape;
computing curvatures of the plurality of image regions based on the data of the 3D model for the plurality image regions;
adjusting sizes of a plurality of mesh elements on a virtual plane disposed virtually at a predetermined distance from the view point, each of the sizes of the plurality of mesh elements being adjusted by using corresponding each one of the curvatures of the plurality of image regions computed in the computing; and
generating a wide-angle image imaged through a wide-angle lens used in the imaging unit by applying aberration data of the wide-angle lens to the captured image generated at the generating according to the sizes of the mesh elements adjusted in the adjusting.

8. A simulation device comprising:
a processor; and
a memory, wherein the processor executes generating a captured image captured by an imaging unit disposed virtually at a predetermined view point in a 3D model, the captured image being generated by using data of the 3D model;
dividing the captured image generated in the generating into a plurality of image regions in a predetermined polygonal shape;
computing curvatures of the plurality of image regions based on the data of the 3D model for the plurality image regions;
adjusting sizes of a plurality of mesh elements on a virtual plane disposed virtually at a predetermined distance from the view point, each of the sizes of the plurality of mesh elements being adjusted by using corresponding each one of the curvatures of the plurality of image regions computed in the computing; and
generating a wide-angle image imaged through a wide-angle lens used in the imaging unit by applying aberration data of the wide-angle lens to the captured image generated at the generating according to the sizes of the mesh elements adjusted in the adjusting.
